(19) United States
(12) Patent Application Publication
(10) Pub. No.: US 2024/0348317 A1
(43) Pub. Date: Oct. 17, 2024

(54) REDUCED OVERHEAD BEAM TRACKING

(71) Applicant: Samsung Electronics Co., Ltd., Suwon-si (KR)

(72) Inventors: Mustafa Furkan Ozkoc, Plano, TX (US); Jianhua Mo, Allen, TX (US); Jeehwan Noh, Suwon-si (KR); Young Han Nam, Plano, TX (US)

(21) Appl. No.: 18/517,570

(22) Filed: Nov. 22, 2023

Related U.S. Application Data
(60) Provisional application No. 63/458,838, filed on Apr. 12, 2023.

(51) Int. Cl. H04B 7/06; H04W 24/10

(52) U.S. Cl. CPC H04B 7/0696; H04W 24/10

(57) ABSTRACT

A method includes selecting, by a base station, a partial search set based on one or more previous measurement reports from a user equipment (UE), the partial search set comprising a set of narrow beams that is a subset of an extended search set associated with an extended search. The method also includes performing, by the base station, a beam tracking search that sweeps the partial search set in order to select a next narrow beam. The method further includes communicating with the UE using the selected next narrow beam.

### CROSS-REFERENCE TO RELATED APPLICATIONS AND CLAIM OF PRIORITY

The present application claims priority to U.S. Provisional Patent Application No. 63/458,838 filed on Apr. 12, 2023. The content of the above-identified patent document is incorporated herein by reference.

### TECHNICAL FIELD

The present disclosure relates generally to wireless communication systems and, more specifically, the present disclosure relates to a system and method for reduced overhead beam tracking.

### BACKGROUND

Beam management is an important and required procedure in mmWave frequencies. The mmWave beam codebook design is very important and challenging for 5G mmWave base stations. Different from the low frequency bands, beamforming is needed to support the high data transmission at the mmWave band due to the large mmWave band path-loss. A significant number of beams (e.g., more than 100 beams) may be needed to cover a wide angular region, for example, horizontally from −60 degrees to +60 degrees. On the other hand, many reference signals are needed to find out the best beam between the base station (BS) and the user equipment (UE).

### SUMMARY

The present disclosure relates to wireless communication systems and, more specifically, the present disclosure relates to a system and method for reduced overhead beam tracking.

In one embodiment, a method includes selecting, by a base station, a partial search set based on one or more previous measurement reports from a user equipment (UE), the partial search set comprising a set of narrow beams that is a subset of an extended search set associated with an extended search. The method also includes performing, by the base station, a beam tracking search that sweeps the partial search set in order to select a next narrow beam. The method further includes communicating with the UE using the selected next narrow beam.

In another embodiment, a device includes a transceiver and a processor operably connected to the transceiver. The processor is configured to: select a partial search set based on one or more previous measurement reports from a UE, the partial search set comprising a set of narrow beams that is a subset of an extended search set associated with an extended search; perform a beam tracking search that sweeps the partial search set in order to select a next narrow beam; and communicate with the UE using the selected next narrow beam.

In yet another embodiment, a non-transitory computer readable medium includes program code that, when executed by a processor of a device, causes the device to: select a partial search set based on one or more previous measurement reports from a UE, the partial search set comprising a set of narrow beams that is a subset of an extended search set associated with an extended search; perform a beam tracking search that sweeps the partial search set in order to select a next narrow beam; and communicate with the UE using the selected next narrow beam.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4 illustrates an example beamforming architecture according to embodiments of the present disclosure;

FIG. 5 illustrates an example of a composite beam transmission using a single antenna array according to embodiments of the present disclosure;

FIG. 6 illustrates an example of a full search algorithm that can be performed as a hierarchical beam search according to embodiments of the present disclosure;

FIG. 7 illustrates an example of an extended search algorithm that can be performed as a hierarchical beam search according to embodiments of the present disclosure;

FIG. 8 illustrates a table showing an example of full search sets according to embodiments of the present disclosure;

FIG. 9 illustrates a table showing an example of extended search sets according to embodiments of the present disclosure;

FIG. 10 illustrates an example process for partial search beam tracking according to embodiments of the present disclosure;

FIG. 11 illustrates a chart showing the potential throughput gains for one example partial search set size according to embodiments of the present disclosure;

FIG. 12 illustrates an example flowchart of the construction of a partial search set according to embodiments of the present disclosure;

FIG. 13 illustrates a graphic representation of various groups in the priority order of a partial search set according to embodiments of the present disclosure;

FIG. 14 illustrates an example beam pattern that shows the construction of the partial search set according to embodiments of the present disclosure;

FIG. 15 illustrates an example partial search table that includes partial search sets according to embodiments of the present disclosure;

FIGS. 16 and 17 illustrate example flowcharts of a PS-Lite algorithm according to embodiments of the present disclosure; and

FIG. 18 illustrates a method for reduced overhead beam tracking according to embodiments of the present disclosure.

### DETAILED DESCRIPTION

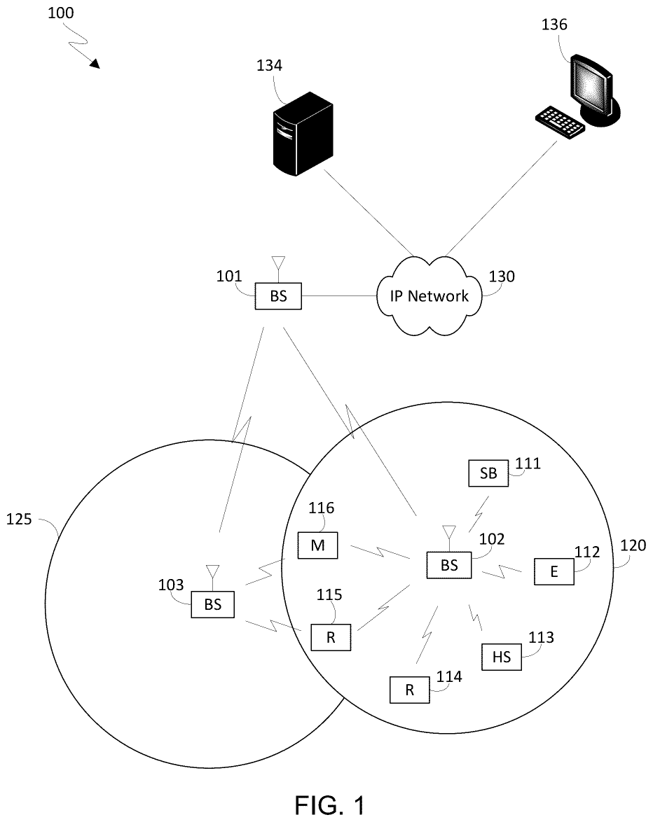

FIGS. 1 through 18, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

The present disclosure covers several components which can be used in conjunction or in combination with one another or can operate as standalone schemes. Certain embodiments of the disclosure may be derived by utilizing a combination of several of the embodiments listed below. Also, it should be noted that further embodiments may be derived by utilizing a particular subset of operational steps as disclosed in each of these embodiments. This disclosure should be understood to cover all such embodiments.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3, discussed below, describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

In some embodiments, the network 130 facilitates communications between at least one server 134 and various client devices, such as a client device 136. The server 134 includes any suitable computing or processing device that can provide computing services for one or more client devices. The server 134 could, for example, include one or more processing devices, one or more memories storing instructions and data, and one or more network interfaces facilitating communication over the network 130.

The client device 136 represents any suitable computing or processing device that interacts with at least one server or other computing device(s) over the network 130. In this example, the client device is represented as a desktop computer, but other examples of client devices can include a mobile telephone, laptop computer, or tablet computer. However, any other or additional client devices could be used in the wireless network 100.

In this example, client devices can communicate indirectly with the network 130. For example, some client devices can communicate via one or more base stations, such as cellular base stations or eNodeBs. Also, client devices can communicate via one or more wireless access points (not shown), such as IEEE 802.11 wireless access points. Note that these are for illustration only and that each client device 136 could communicate directly with the network 130 or indirectly with the network 130 via any suitable intermediate device(s) or network(s).

As described in more detail below, a computing device, such as the server 134 or the client device 136, may perform operations in connection with beam management. For example, the server 134 or the client device 136 may perform operations in connection with reduced overhead beam tracking as discussed herein.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

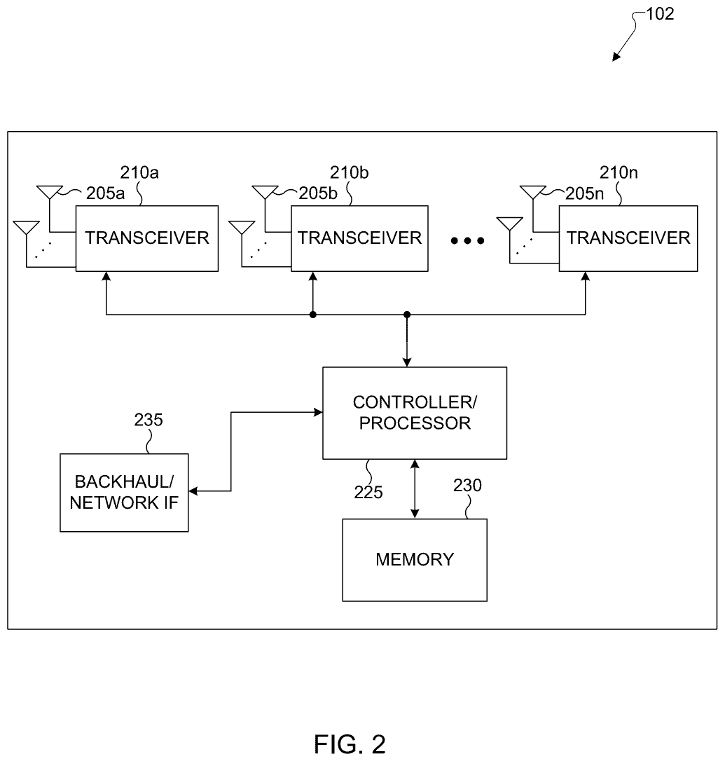

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support reduced overhead beam tracking as discussed herein. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

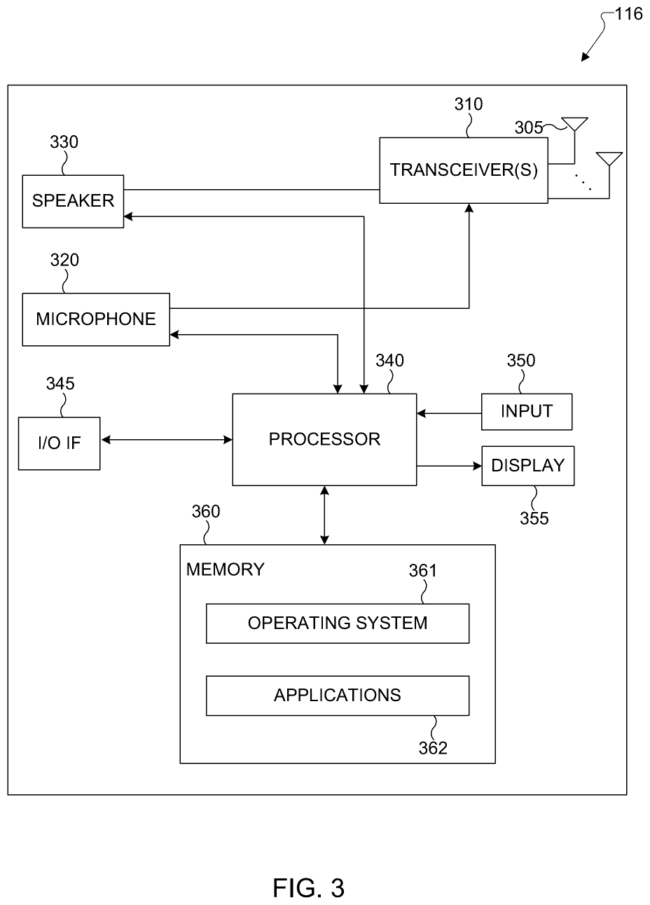

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for reduced overhead beam tracking. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 (which includes for example, a touchscreen, keypad, etc.) and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

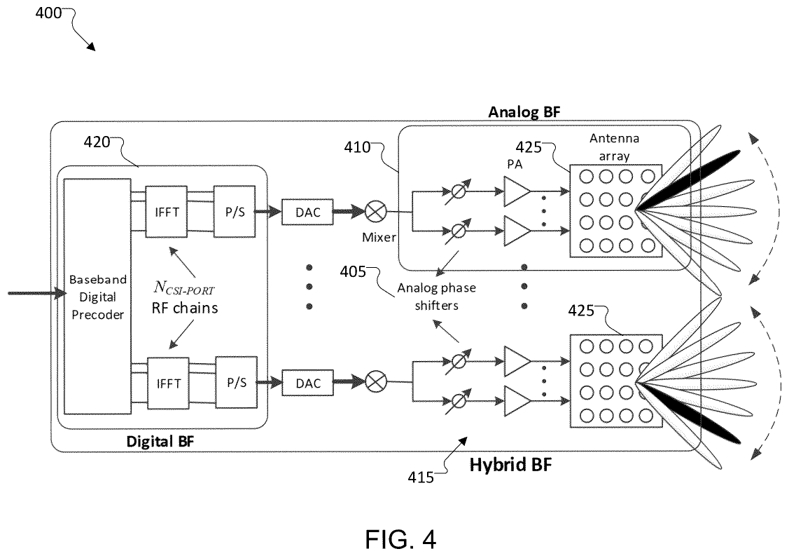

FIG. 4 illustrates an example beamforming architecture 400 according to embodiments of the present disclosure. The embodiment of the beamforming architecture 400 illustrated in FIG. 4 is for illustration only. FIG. 4 does not limit the scope of this disclosure to any particular implementation of the beamforming architecture 400. In certain embodiments, one or more of gNB 102 or UE 116 can include the beamforming architecture 400. For example, one or more of antenna 205 and its associated systems or antenna 305 and its associated systems can be configured the same as or similar to the beamforming architecture 400.

Rel.14 LTE and Rel.15 NR support up to 32 channel state information reference signal (CSI-RS) antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of analog-to-digital converts/digital-to-analog converts (ADCs/DACs at mmWave frequencies)).

In the example shown in FIG. 4, the beamforming architecture 400 includes analog phase shifters 405, an analog beamformer (BF) 410, a hybrid BF 415, a digital BF 420, and one or more antenna arrays 425. In this case, one CSI-RS port is mapped onto a large number of antenna elements in antenna arrays 425, which can be controlled by the bank of analog phase shifters 405. One CSI-RS port can then correspond to one sub-array which produces a narrow analog beam through analog beamforming by analog BF 410. The analog beam can be configured to sweep across a wider range of angles by varying the phase shifter bank 405 across symbols or subframes. The number of sub-arrays (equal to the number of RF chains) is the same as the number of CSI-RS ports NCSI-PORT. The digital BF 420 performs a linear combination across NCSI-PORT analog beams to further increase precoding gain. While analog beams are wideband (hence not frequency-selective), digital precoding can be varied across frequency sub-bands or resource blocks.

Since the above system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL transmit (TX) beam (also termed “beam indication”), measuring at least one reference signal for calculating and performing beam reporting (also termed “beam measurement” and “beam reporting”, respectively), and receiving a DL or UL transmission via a selection of a corresponding receive (RX) beam.

Additionally, the beamforming architecture 400 is also applicable to higher frequency bands such as >52.6 GHz (also termed the FR4). In this case, the beamforming architecture 400 can employ only analog beams. Due to the O2 absorption loss around 60 GHz frequency (˜10 decibels (dB) additional loss @100 m distance), larger numbers of and sharper analog beams (hence larger number of radiators in the array) will be needed to compensate for the additional path loss.

As discussed above, beam management is an important and required procedure in mmWave frequencies. The mmWave beam codebook design is very important and challenging for 5G mmWave base stations. Different from the low frequency bands, beamforming is needed to support the high data transmission at the mmWave band due to the large mmWave band path-loss. A significant number of beams (e.g., more than 100 beams) may be needed to cover a wide angular region, for example, horizontally from −60 degrees to +60 degrees. On the other hand, many reference signals are needed to find out the best beam between the BS and the UE. Hierarchical beam codebooks can be used where a large number of narrow beams cover an area for high gain, while a smaller number of wide beams cover the area and limit the synchronization signal blocks (SSBs) overhead. The wide beams and narrow beams have a parent-child relationship. Beam tracking can be achieved using the parent-child relationship by identifying the best wide beam, and then searching for the best narrow beam among the children of the wide beam.

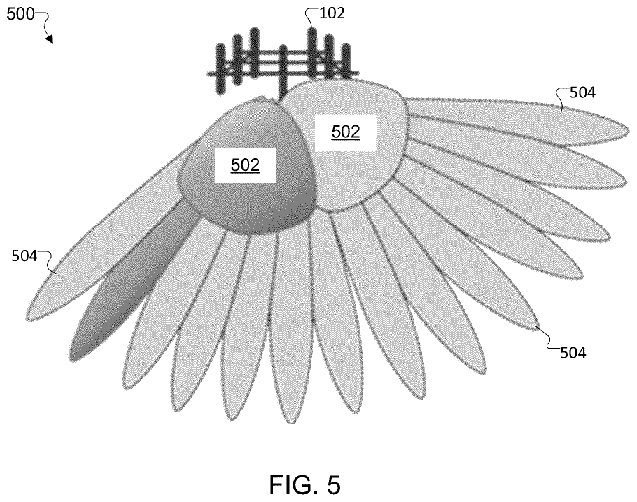

FIG. 5 illustrates an example of a composite beam transmission using a single antenna array 500 according to embodiments of the present disclosure. The antenna array 500 is for illustration only and other embodiments can be used without departing from the scope of the present disclosure.

As shown in FIG. 5, the antenna array 500 can be a component of, for example, the BS 102, and can transmit two wide beams 502 and fourteen narrow beams 504, where each wide beam 502 has seven children narrow beams 504. The example only shows the beam distribution in one dimension. In a hierarchical beam search, the two wide beams 502 are first transmitted by the BS 102 in order to identify the best wide beam 502. Then the BS 102 transmits the seven narrow beams 504 belonging to the best wide beam 502 to a UE (such as the UE 116). The UE measures the signal quality (e.g., RSRP, RSRQ, SNR, CQI, or the like) of the seven narrow beams 504 and feeds back to the BS 102. The narrow beam search is performed for each UE connected to the BS 102 and is performed periodically (e.g., every 80 ms) to track the UE movement or any change of propagation environment. The signaling overhead of narrow beam transmission is large if there is a large number of narrow beams. On the other side, if a subset of narrow beams is searched, there could be a performance loss if the true best narrow beam is not included in the search set.

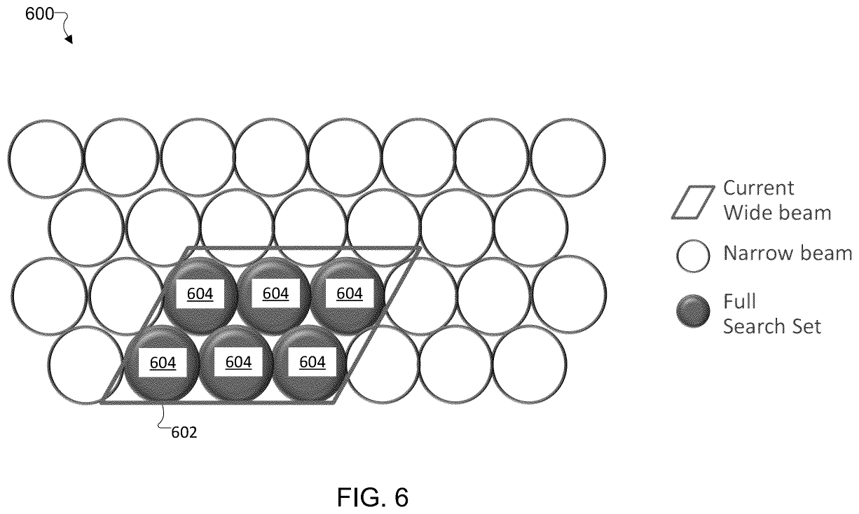

FIG. 6 illustrates an example of a full search algorithm 600 that can be performed as a hierarchical beam search according to embodiments of the present disclosure. As shown in FIG. 6, a wide beam 602 (which can represent one of the wide beams 502 of FIG. 5) includes multiple child narrow beams 604 (which can represent some of the narrow beams 504 of FIG. 5). During the full search algorithm 600, the BS transmits over the full search set, which includes each of the narrow beams 604 for the wide beam 602. This type of full search algorithm 600 typically has a large measurement overhead and low beam tracking accuracy.

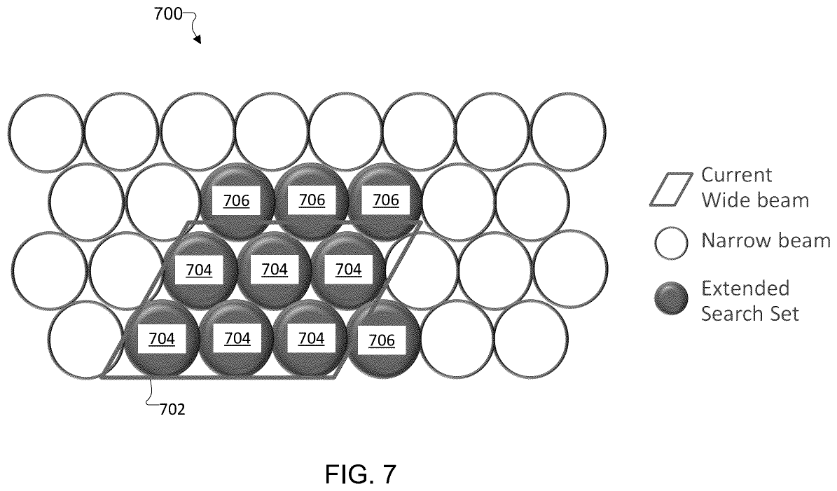

FIG. 7 illustrates an example of an extended search algorithm 700 that can be performed as a hierarchical beam search according to embodiments of the present disclosure. As shown in FIG. 7, a wide beam 702 (which can represent one of the wide beams 502 of FIG. 5) includes multiple child narrow beams 704 (which can represent some of the narrow beams 504 of FIG. 5). During the extended search algorithm 700, the BS transmits over the extended search set, which includes K narrow beams for the wide beam 702. The K narrow beams include the child narrow beams 704 of the wide beam 702, and also includes one or more nearby narrow beams 706 that are adjacent to the child narrow beams 704. In FIG. 7, K is equal to 10 total narrow beams, including the six child narrow beams 704 and the four nearby narrow beams 706. Of course, other values for K are possible and within the scope of this disclosure. The nearby narrow beams 706 are determined by their overlap with the wide beam 702. This type of extended search algorithm 700 typically has a large measurement overhead. This can reduce overall system efficiency.

To address these and other issues, this disclosure provides systems and methods for reduced overhead beam tracking. The disclosed embodiments feature partial search techniques that track the best beam for the highest gain, while reducing the search overhead. The disclosed techniques include a partial beam sweep that sweeps only a partial search set comprising a subset of narrow beams. In some embodiments, the partial search set size could be half of the size of an extended search set. The disclosed techniques also include construction of the partial search set. Accuracy of the beam tracking depends on how well the beam sweep set is constructed.

Some of the embodiments discussed below are described in the context of mmWave bands. Of course, these are merely examples. It will be understood that the principles of this disclosure may be implemented in any number of other suitable contexts, systems, or frequency bands. It is also noted that although some examples describe measurements of RSRP, the UE measurements of the channel could be reference signal received quality (RSRQ), channel quality indicator (CQI), signal-to-noise-ratio (SNR), signal-to-interference-noise-ratio (SINR), and the like. The embodiments in this disclosure can be applied to those measurement metrics as well.

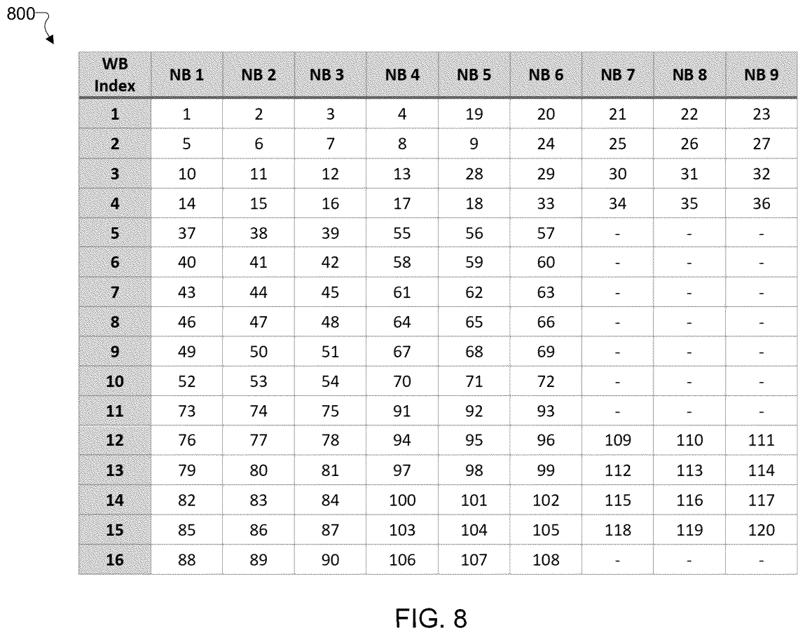

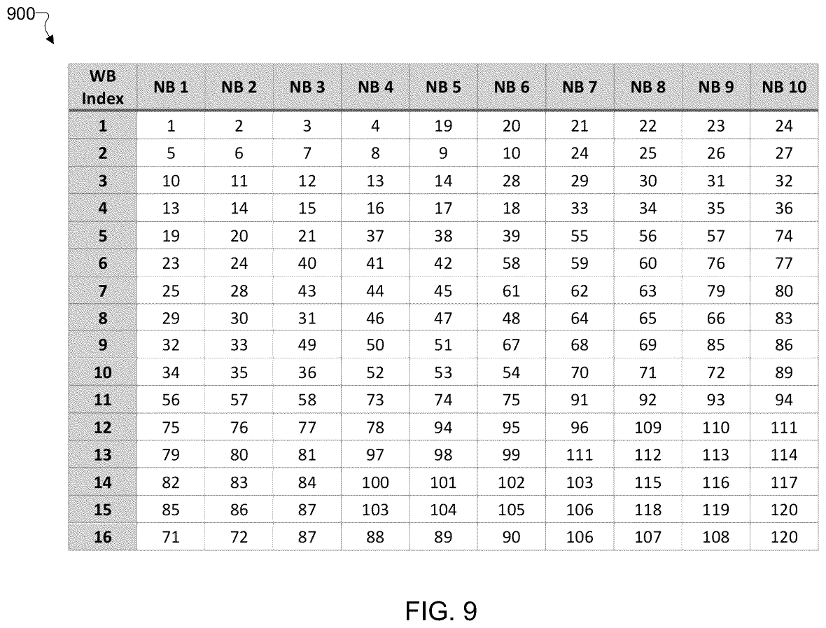

As described above in conjunction with FIGS. 6 and 7, the full search algorithm 600 and the extended search algorithm 700 are hierarchical beam search techniques that can be used as a baseline for the partial search techniques disclosed herein. The full search set size is varying, depending on the coverage region of the wide beam. FIG. 8 illustrates a table 800 showing an example of the full search sets according to embodiments of the present disclosure. In the table 800, the full search set includes 16 wide beams and 120 narrow beams. As shown in FIG. 8, some of the wide beams have 9 children narrow beams, while other beams have only 5 children narrow beams. Extended search sets have the same size across the wide beams. However, extended search sets contain a large number of narrow beams which results in significant beam tracking overhead. FIG. 9 illustrates a table 900 showing an example of extended search sets according to embodiments of the present disclosure. As shown in FIG. 9, every row of the table 900 has 10 narrow beams.

The baseline full search and extended search sets are only decided by the wide beam index. The full and extended search sets are decided offline (i.e., decided at a prior time) and saved in the memory. The BS can search the narrow beams from the set online (i.e., the search is performed in real time) based on the latest wide beam measurement results.

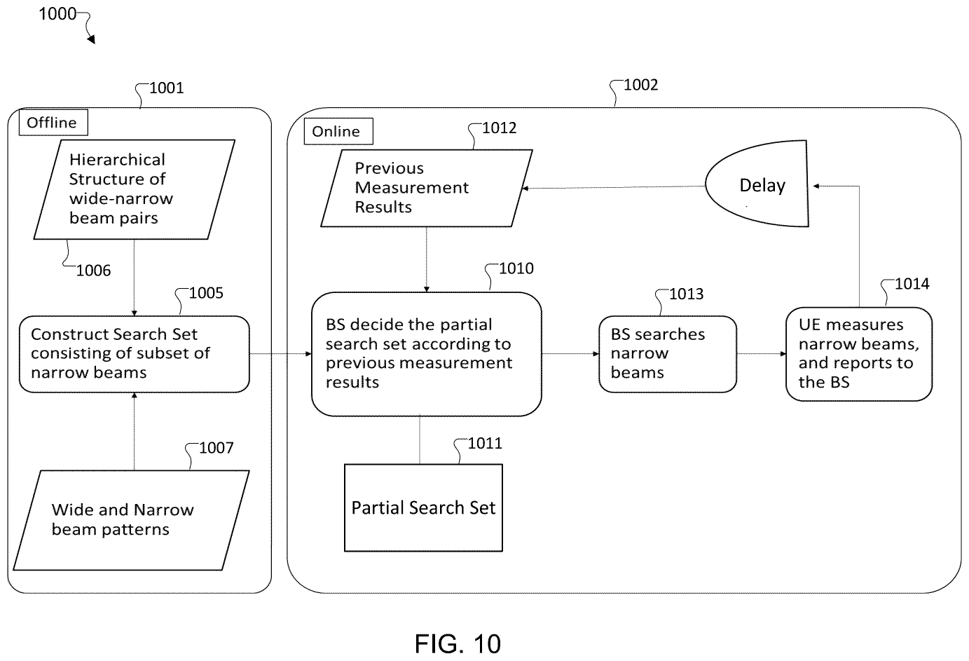

FIG. 10 illustrates an example process 1000 for partial search beam tracking according to embodiments of the present disclosure. The partial search, which only sweeps a subset of narrow beams, can be used as part of a hierarchical beam search. For ease of explanation, the process 1000 will be described as implemented by the BS 102 and the UE 116 of FIG. 1; however, the process 1000 could be implemented by any other suitable device or system. The embodiment of the process 1000 shown in FIG. 10 is for illustration only. Other embodiments of the process 1000 could be used without departing from the scope of this disclosure.

As shown in FIG. 10, the process 1000 includes both offline operations 1001 and online operations 1002. As discussed above, the offline operations 1001 can be performed at a previous time and saved in the memory of the BS 102. The online operations 1002 can be performed in real time. In some embodiments, at least portions of the offline operations 1001 could additionally or alternatively be performed online, for example, if the computational costs of such operations could be accommodated in the real-time operation budget.

The offline operations 1001 include construction of a search set 1005. In some embodiments, the BS 102 can construct the search set 1005 by utilizing the hierarchical beam structure of the wide and narrow beam pairs 1006 (i.e., the hierarchical relationships between wide and narrow beams, such as the hierarchical beam structure shown in FIG. 5, which can be defined in the hierarchical beam codebook), one or more beam patterns of wide and narrow beams 1007 (which can include, for example, patterns of beams in a full search, patterns of beams in an extended search, or the like), previous search results, or some combination of two or more of these. In some embodiments, the previous search results can include only the results of the most recent previous search. However, in other embodiments, the results of more than one previous search could also be utilized. Once constructed, the search set 1005 can be saved in a memory of the BS 102.

While the search set 1005 is described as being constructed offline as part of the offline operations 1001, it is noted that the search set 1005 can be at least partially constructed online as part of the online operations 1002. For example, frequently used search sets could be constructed offline and stored in the memory of the BS 102, while infrequently used search sets could be constructed online on an as-needed basis.

The online operations 1002 include operation 1010, in which the BS 102 selects a partial search set 1011 from the search set 1005 according to one or more previous measurement results 1012. The partial search set 1011 will be swept in the beam tracking search to select a next narrow beam. In some typical beam tracking implementations, wide beams are tracked using SSBs and the narrow beams are tracked using CSI-RS measurements. In some implementations, wide beams could also be tracked using CSI-RS measurements. A partial search set 1011 that results in a large set of narrow beam measurements from the UE 116 could increase the probability of detecting the best narrow beam with the highest gain. A small set of narrow beam measurements could keep the CSI-RS resource use to a minimum and could increase the resources remaining for data transmission. However, with a smaller partial search set 1011, the best narrow beam could be missed and could result in loss of potential beamforming gain. Thus, there is a tradeoff between the overhead of measuring many narrow beams and achieving the highest beamforming gain.

In some embodiments, the BS 102 can select the partial search set 1011 as small as possible while still achieving highest (or high enough) beamforming gain. In one deployment scenario the CSI-RS measurements could be performed periodically. The throughput per UE is given as:

$${T}_{i}^{UE} = ( 1 - \frac{{N}_{UE} M}{A} ) \frac{BW}{{N}_{UE}} f ( {RSRP}_{i} ) ,$$

where Tᵢ^{UE} is the throughput of UE i, N_{UE} is the number of UEs in the cell, M is the narrow beam search set size (i.e., how many CSI-RS resource slots are used for the narrow beam search set per UE), BW and

$$\frac{BW}{{N}_{UE}}$$

are total system bandwidth and bandwidth per UE for an equal allocation
example, f(RSRPᵢ) is the spectral efficiency (bits/s/Hz) achieved by the best narrow beam from the search set, and A is the total number of slots in one narrow beam measurement period. Here, the value of A can be computed as:

$$A = \frac{{T}_{NB}}{{D}_{slot}} {R}_{DL}$$

where T_{NB} is the narrow beam measurement periodicity (e.g., 120 ms), Dₛₗₒₜ is the slot duration (e.g., 0.125 ms for 120 kHz subcarrier spacing), and R_{DL} is the ratio of slots used for downlink to all slots.

For a typical example where T_{NB}=120 ms, Dₛₗₒₜ=0.125 ms, and

$${R}_{DL} = \frac{3}{5} 12 + \frac{1}{5} * 8 ,$$

the number of total slots A=8448. For an example extended search set size of M=10 and an example cell with N_{UE}=256 UEs, the fraction of slots left for the data transmission is

$$( 1 - 256 * \frac{10}{8448} ) = 0.697 .$$

In some embodiments, the size of the partial search set 1011 could be designed to be half of the extended search set size M/2=5. In this example, the fraction of slots left for data transmission is

$$( 1 - 256 * \frac{5}{8448} ) = 0.8485 .$$

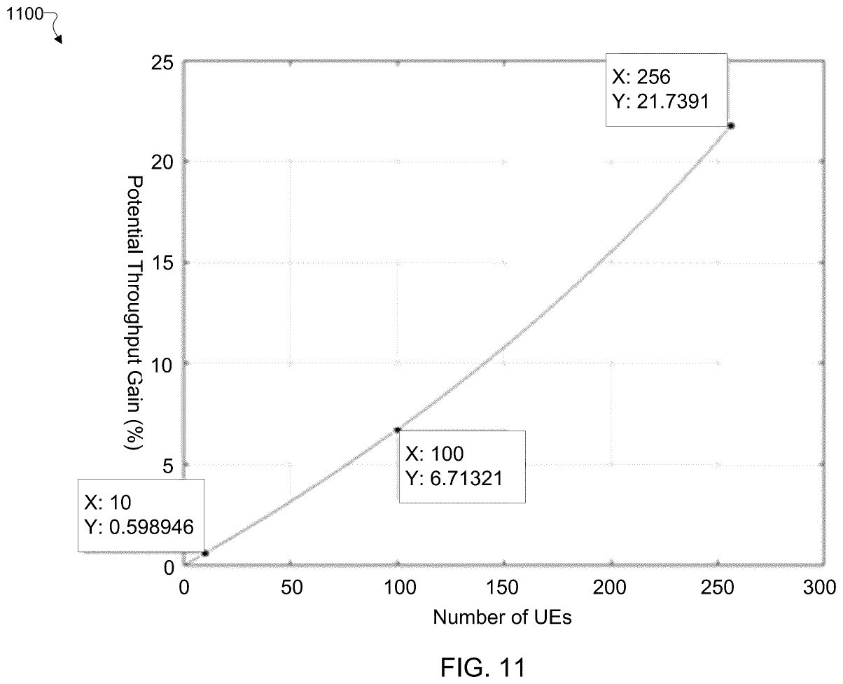

In other words, using the partial search algorithm 21.7% more data transmission slots are available for data transmission. FIG. 11 illustrates a chart 1100 showing the potential throughput gains for one example partial search set size according to embodiments of the present disclosure.

### Partial Search Set Construction

In some embodiments, one partial search set 1011 can be constructed for every possible wide beam index and narrow beam index pair. The best narrow beam index and best wide beam index pair is identified according to the previous measurement results 1012. The partial search set 1011 constructed for the best pair identified in the most recent previous measurement can be used as the search set for the current search.

In some embodiment, one partial search set 1011 can be constructed for each pair of narrow beam index and wide beam index. Thus, the narrow beam index and the wide beam index can be viewed as the input, and the partial search set 1011 can be viewed as the output. Other input combinations can include (but are not limited to) the last two best narrow beam indices (i.e., previous best NB and the best NB before that), the last two wide beam indices, or the last two narrow beam and wide beam indices.

In some embodiments, the size of the partial search set 1011 could be different for different input options. The size of the partial search set 1011 could be small to further reduce the overhead, or could be large to increase the beam tracking accuracy. In one example, the partial search for inputs of narrow beam index i, and wide beam index j can be constructed to be half of the size of the extended search set of wide beam j. In some embodiments, the partial search set 1011 can be constructed by using a small subset of narrow beams from the full search and extended search sets (such as shown in FIGS. 6 and 7).

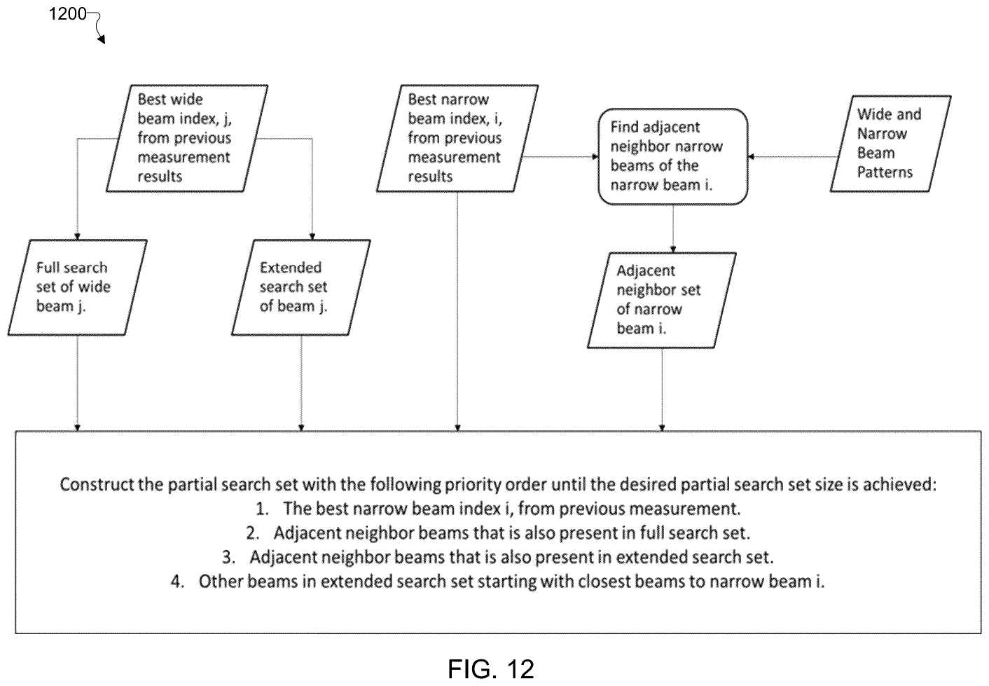

FIG. 12 illustrates an example flowchart 1200 of the construction of the partial search set 1011 according to embodiments of the present disclosure. As shown in FIG. 12, the partial search set 1011 for inputs of narrow beam index i and wide beam index j can be constructed using the following first-to-last priority order until the desired size of the partial search set 1011 is achieved. In some embodiments, this order is based on a likelihood that each narrow beam is a best beam given the one or more previous measurement results 1012.
1. The narrow beam index i from the most recent previous measurement.
2. Neighbor beams adjacent to index i that are also present in the full search set.
3. Neighbor beams adjacent to index i that are also present in the extended search set.
4. Other, non-neighbor beams in the extended search set.

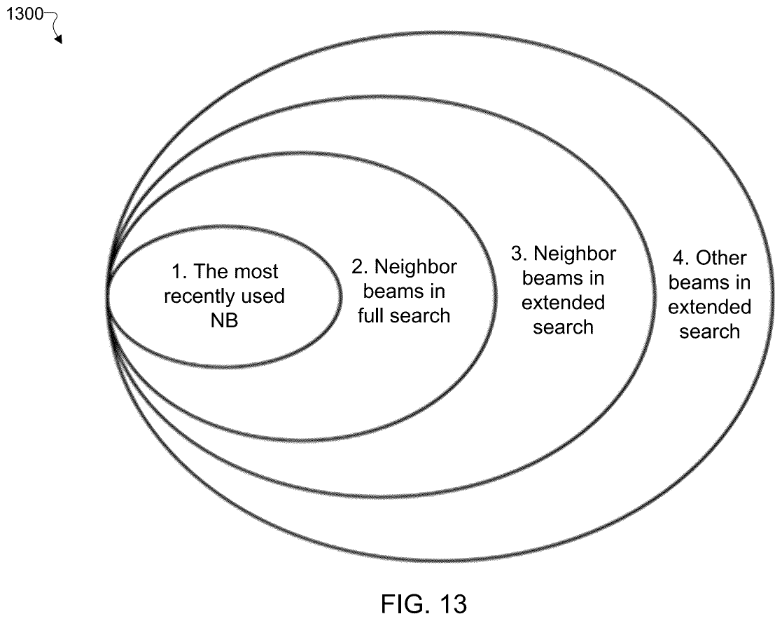

FIG. 13 illustrates a graphic representation 1300 of these groups in the priority order listed above. Of course, this priority order is merely one example and is not restrictive. Other priority orders can be used to construct the partial search set 1011, and are within the scope of this disclosure. In the determination of the partial search set 1011, the closeness of two narrow beams can be computed using the angular distance between the centers of two narrow beams. The center of a narrow beam is the location in angular domain where the peak gain is achieved for that particular narrow beam.

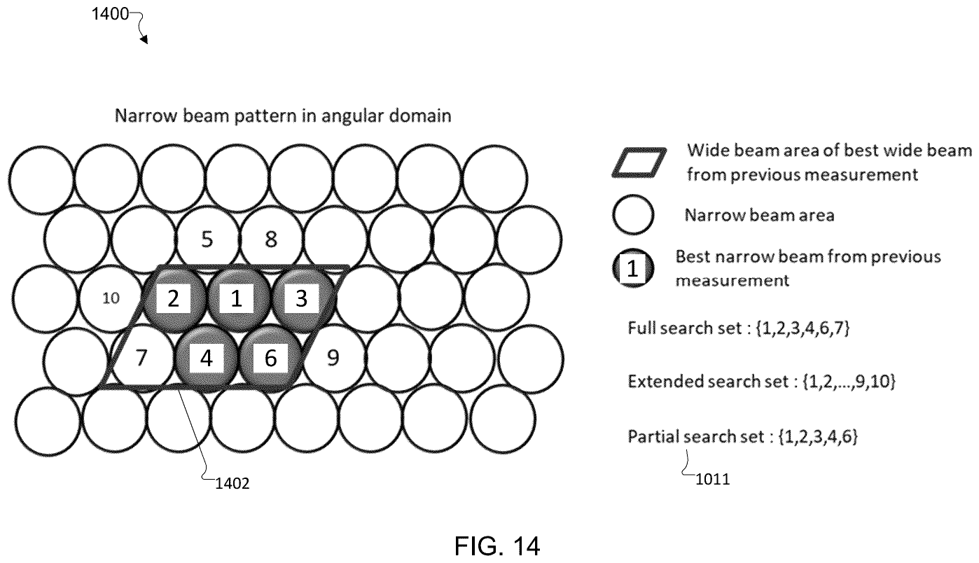

FIG. 14 illustrates an example beam pattern 1400 that shows the construction of the partial search set 1011 according to embodiments of the present disclosure. As shown in FIG. 14, the beam pattern 1400 represents a narrow beam pattern in the angular domain. A wide beam area of the best wide beam 1402 from the previous measurement includes multiple child narrow beams represented by circles. Here, the best wide beam 1402 can represent one of the wide beams 502 of FIG. 5, and each of the child narrow beams can represent one of the narrow beams 504 of FIG. 5. The child narrow beams include a best narrow beam from the previous measurement (identified as ‘1’). During beam tracking, the BS 102 can select a subset of the child narrow beams (identified as {‘1’, ‘2’, ‘3’, ‘4’, ‘6’} in FIG. 14) as the partial search set 1011. The partial search set 1011 may be a subset of the full search set, the extended search set, or both.

Turning again to FIG. 10, once the partial search set 1011 has been selected, then at operation 1013, the BS 102 searches the narrow beams in the partial search set 1011 and sends reference signals to the UE 116. At operation 1014, the UE 116 measures the narrow beams in the partial search set 1011 and reports the measurements to the BS 102. As discussed above, different options exist as to how much information the UE 116 reports back to the BS 102. In some embodiments, the UE 116 reports only the best beam. In some embodiments, the UE 116 reports the best beam and the second best beam. Other combinations of reporting information are possible. Once the beam tracking search is complete, the BS 102 can select the best narrow beam to use for communicating with the UE 116.

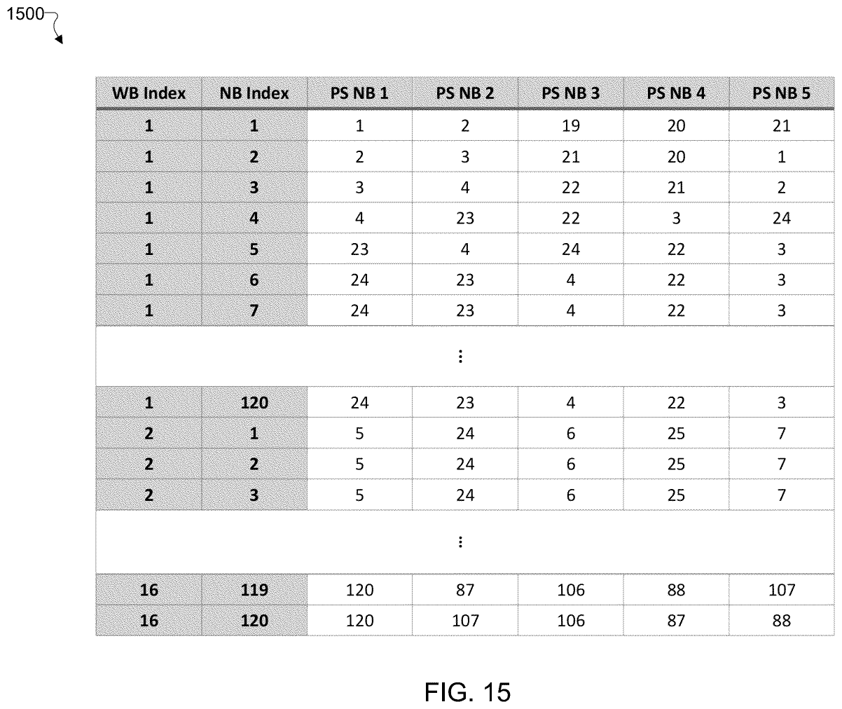

In some embodiments, one or more partial search sets 1011 could be stored in memory as a lookup table that includes the input narrow beam index, input wide beam index, and the beam indices for the search set. FIG. 15 illustrates an example partial search table 1500 that includes partial search sets 1011 according to embodiments of the present disclosure. Storing the partial search sets 1011 in a lookup table could be desirable for reasons including (but not limited to) reducing the computational burden on the base station, and reducing the time required to construct the partial search set 1011.

In such lookup table deployments, the partial search table 1500 may have a large number of rows, namely in this example, number of narrow beams*number of wide beams. For each such row, a partial search set 1011 can be stored which can have a size of M/2=5. For a typical example codebook with 120 narrow beams and 16 wide beams, the total number of stored elements in the partial search table 1500 is 120*16*7=13,440, where a total of 7 beam indices are stored per row including 5 indices for the search set and two indices for NB and WB to address. Depending on the implementation, this resulting large table size could have a prohibitively large storage cost. The storage size of the partial search table 1500 could be reduced by different methods. A non-exhaustive list of potential storage size reduction methods are as follows:
Storing only the narrow beam-wide beam pairs present in the full search (i.e., for each narrow beam, only its parent wide beam is included in the storage).
Storing only the narrow beam-wide beam pairs present in the extended search.
Storing only narrow beam-wide beam pairs such that, for each narrow beam, only its parent wide beam and the wide beams adjacent to its parent in angular domain are included in the storage.
Using cell-common or cell-specific simulations to identify potential narrow beam-wide beam pairs that could be observed and storing only these pairs.

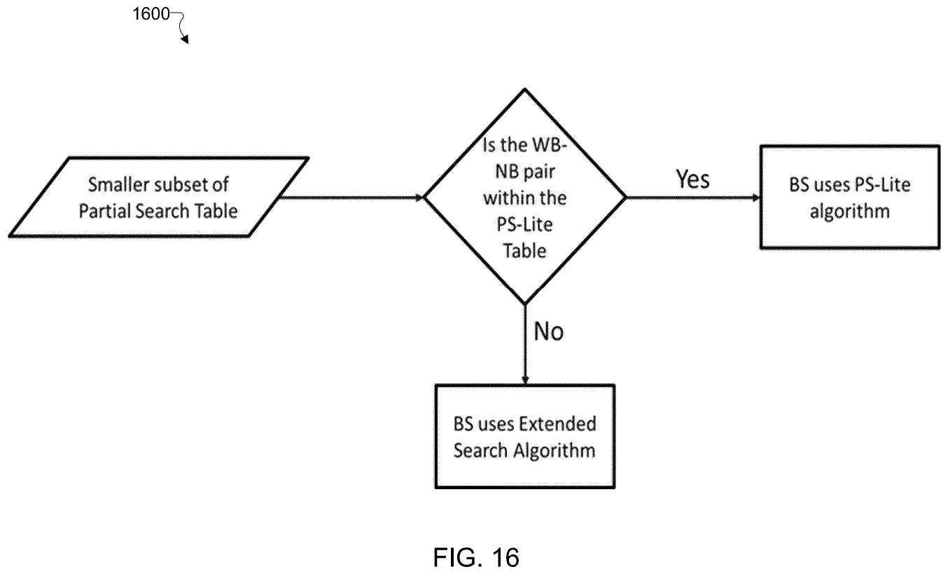

In cases where the partial search table 1500 has been reduced in storage size using any of the above methods, the resulting table can be referred to a partial search lite (PS-Lite) table. In PS-Lite deployments, new wide beam and narrow beam indices could be observed that are not in the PS-Lite table. In some embodiments, the baseline extended search algorithm could be used as a backup algorithm. FIG. 16 illustrates an example flowchart 1600 of the PS-Lite algorithm using the extended search as a backup algorithm, according to embodiments of the present disclosure. In alternative embodiments, the full search could be used as a backup mechanism.

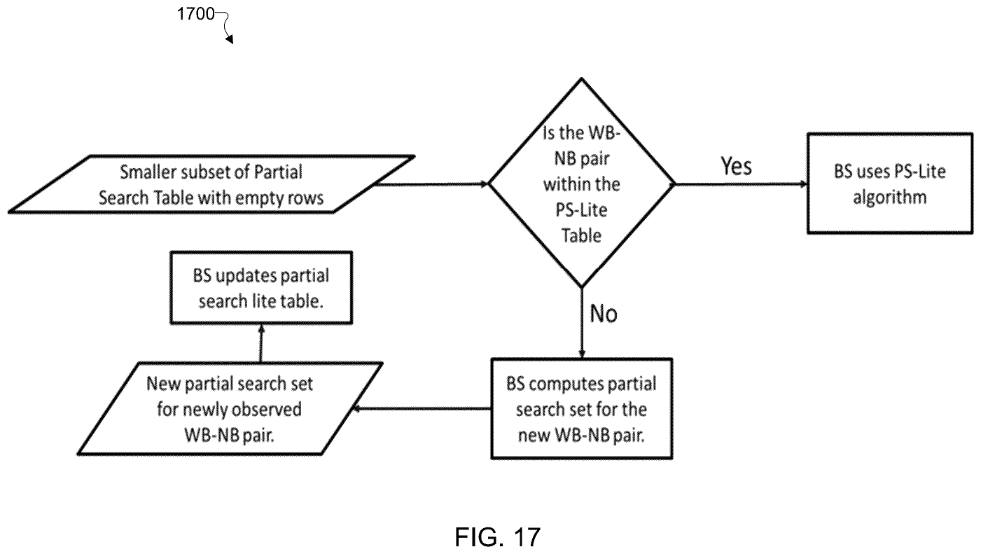

In some embodiments, if a narrow beam-wide beam combination is observed, the partial search set 1011 could be computed online. This could have additional computational complexity during the runtime. Accordingly, in some embodiments, an initial PS Lite table could include some empty rows, and reserve storage space. As new narrow beam-wide beam combinations are observed, the partial search set for these combinations could be computed and included in the reserved empty rows. FIG. 17 illustrates another example flowchart 1700 of the PS-Lite algorithm according to embodiments of the present disclosure. As shown in FIG. 17, empty rows are reserved for the storage space, and the partial search is computed and recorded once a new wide beam narrow beam combination is observed. In some embodiments, the reserve rows could be cell specific which could be different for different cells.

Although FIGS. 6 through 17 illustrate various processes and details related to reduced overhead beam tracking, various changes may be made to FIGS. 6 through 17. For example, various components in FIGS. 6 through 17 could be combined, further subdivided, or omitted and additional components could be added according to particular needs. In addition, various operations in FIGS. 6 through 17 could overlap, occur in parallel, occur in a different order, or occur any number of times.

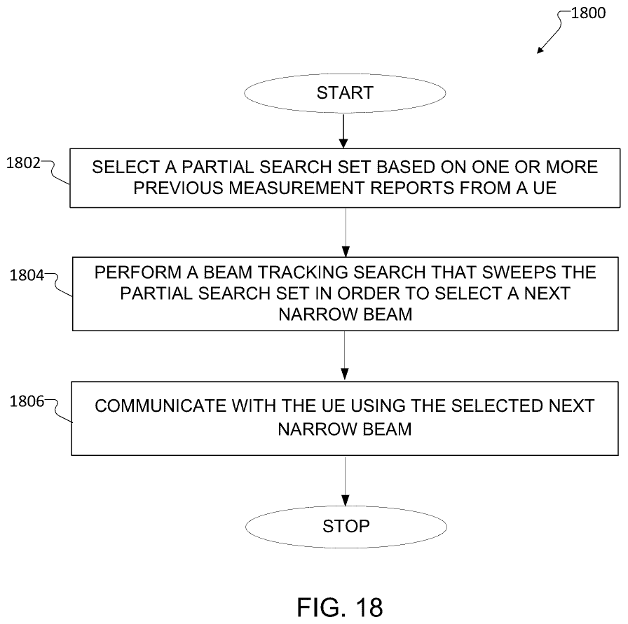

FIG. 18 illustrates a method 1800 for reduced overhead beam tracking according to embodiments of the present disclosure, as may be performed by one or more components of the network 100 (e.g., the BS 102). The embodiment of the method 1800 shown in FIG. 18 is for illustration only. One or more of the components illustrated in FIG. 18 can be implemented in specialized circuitry configured to perform the noted functions or one or more of the components can be implemented by one or more processors executing instructions to perform the noted functions.

As illustrated in FIG. 18, the method 1800 begins at step 1802. At step 1802, a base station selects a partial search set based on one or more previous measurement reports from a UE. The partial search set includes a set of narrow beams that is a subset of an extended search set associated with an extended search. This could include, for example, the BS 102 selecting a partial search set 1011 based on one or more previous measurement results 1012, such as shown in FIG. 10.

At step 1804, the base station performs a beam tracking search that sweeps the partial search set in order to select a next narrow beam. This could include, for example, the BS 102 performing operation 1013, in which the BS 102 searches the narrow beams in the partial search set 1011 and sends reference signals to the UE 116, such as shown in FIG. 10.

At step 1806, the base station communicates with the UE using the selected next narrow beam. This could include, for example, the BS 102 communicating with the UE 116 using the selected next narrow beam.

Although FIG. 18 illustrates one example of a method 1800 for reduced overhead beam tracking, various changes may be made to FIG. 18. For example, while shown as a series of steps, various steps in FIG. 18 could overlap, occur in parallel, occur in a different order, or occur any number of times.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
selecting, by a base station, a partial search set based on one or more previous measurement reports from a user equipment (UE), the partial search set comprising a set of narrow beams that is a subset of an extended search set associated with an extended search;
performing, by the base station, a beam tracking search that sweeps the partial search set in order to select a next narrow beam; and
communicating with the UE using the selected next narrow beam.

2. The method of claim 1, wherein the set of narrow beams in the partial search set is ordered based on a respective likelihood that each beam is a best beam given the one or more previous measurement reports.

3. The method of claim 2, wherein an order of the narrow beams in the partial search set is determined by examining, in a first-to-last priority order, (i) a most recently used narrow beam, (ii) neighbor beams of the most recently used narrow beam in a full search set, (iii) neighbor beams of the most recently used narrow beam in an extended search set, and (iv) non-neighbor beams in the extended search set.

4. The method of claim 1, wherein the partial search set is selected from a second search set determined from a hierarchical beam structure of wide and narrow beam pairs and multiple beam patterns of wide and narrow beams.

5. The method of claim 4, wherein the second search set is constructed online or stored in the base station.

6. The method of claim 4, wherein the second search set is partially stored in the base station for frequently used sets and partially constructed online for infrequent sets.

7. The method of claim 1, wherein the extended search set comprises all children narrow beams of an identified wide beam and additional nearby narrow beams.

8. A device comprising:
a transceiver; and
a processor operably connected to the transceiver, the processor configured to:
select a partial search set based on one or more previous measurement reports from a user equipment (UE), the partial search set comprising a set of narrow beams that is a subset of an extended search set associated with an extended search;
perform a beam tracking search that sweeps the partial search set in order to select a next narrow beam; and
communicate with the UE using the selected next narrow beam.

9. The device of claim 8, wherein the set of narrow beams in the partial search set is ordered based on a respective likelihood that each beam is a best beam given the one or more previous measurement reports.

10. The device of claim 9, wherein an order of the narrow beams in the partial search set is determined by examining, in a first-to-last priority order, (i) a most recently used narrow beam, (ii) neighbor beams of the most recently used narrow beam in a full search set, (iii) neighbor beams of the most recently used narrow beam in an extended search set, and (iv) non-neighbor beams in the extended search set.

11. The device of claim 8, wherein the partial search set is selected from a second search set determined from a hierarchical beam structure of wide and narrow beam pairs and multiple beam patterns of wide and narrow beams.

12. The device of claim 11, wherein the second search set is constructed online or stored in the device.

13. The device of claim 11, wherein the second search set is partially stored in the device for frequently used sets and partially constructed online for infrequent sets.

14. The device of claim 8, wherein the extended search set comprises all children narrow beams of an identified wide beam and additional nearby narrow beams.

15. A non-transitory computer readable medium comprising program code that, when executed by a processor of a device, causes the device to:
select a partial search set based on one or more previous measurement reports from a user equipment (UE), the partial search set comprising a set of narrow beams that is a subset of an extended search set associated with an extended search;
perform a beam tracking search that sweeps the partial search set in order to select a next narrow beam; and
communicate with the UE using the selected next narrow beam.

16. The non-transitory computer readable medium of claim 15, wherein the set of narrow beams in the partial search set is ordered based on a respective likelihood that each beam is a best beam given the one or more previous measurement reports.

17. The non-transitory computer readable medium of claim 16, wherein an order of the narrow beams in the partial search set is determined by examining, in a first-to-last priority order, (i) a most recently used narrow beam, (ii) neighbor beams of the most recently used narrow beam in a full search set, (iii) neighbor beams of the most recently used narrow beam in an extended search set, and (iv) non-neighbor beams in the extended search set.

18. The non-transitory computer readable medium of claim 15, wherein the partial search set is selected from a second search set determined from a hierarchical beam structure of wide and narrow beam pairs and multiple beam patterns of wide and narrow beams.

19. The non-transitory computer readable medium of claim 18, wherein the second search set is constructed online or stored in the device.

20. The non-transitory computer readable medium of claim 18, wherein the second search set is partially stored in the device for frequently used sets and partially constructed online for infrequent sets.
